(19) United States
(12) Patent Application Publication
(10) Pub. No.: US 2015/0356488 A1
(43) Pub. Date: Dec. 10, 2015

(54) Evaluating Workers in a Crowdsourcing Environment

(71) Applicant: Microsoft Corporation, Redmond, WA (US)

(72) Inventors: Semiha Ece Kamar Eden, Redmond, WA (US); Rajesh M. Patel, Woodinville, WA (US); Steven J. R. Shelford, Victoria (CA); Hai Wu, Richmond (CA); David A. Molnar, Seattle, WA (US); Eric J. Horvitz, Kirkland, WA (US)

(21) Appl. No.: 14/300,115

(22) Filed: Jun. 9, 2014

(51) Int. Cl. G06Q 10/06; G06Q 50/00

(52) U.S. Cl. CPC G06Q 10/06395; G06Q 50/01

(57) ABSTRACT

A crowdsourcing environment is described herein which uses a single-stage or multi-stage approach to evaluate the quality of work performed by a worker, with respect to an identified task. In the multi-stage case, an evaluation system, in the first stage, determines whether the worker corresponds to a spam agent. In a second stage, for a non-spam worker, the evaluation system determines the propensity of the worker to perform desirable (e.g., accurate) work in the future. The evaluation system operates based on a set of features, including worker-focused features (which describe work performed by the particular worker), task-focused features (which describe tasks performed in the crowdsourcing environment), and system-focused features (which describe aspects of the configuration of the crowdsourcing environment). According to one illustrative aspect, the evaluation system performs its analysis using at least one model, produced using any type of supervised machine learning technique.

### BACKGROUND

A computer-implemented crowdsourcing system operates by distributing instances of a task to a group of human workers, and then collecting the workers' responses to the task. In some cases, the crowdsourcing system may reward a worker for his or her individual contribution, on behalf of the entity which sponsors or “owns” the task. For example, the crowdsourcing system may give each worker a small amount of money for each task that he or she completes.

A crowdsourcing system provides no direct supervision of the work performed by its workers. A crowdsourcing system may also place no (or minimal) constraints on workers who are permitted to work on tasks. As a result, the quality of work performed by different workers may vary. Some workers are diligent and perform high-quality responses. Other workers provide lower quality work, to varying degrees. Indeed, at one end of the quality spectrum, some workers may correspond to spam agents which quickly perform a large quantity of low-quality work for financial gain and/or to achieve other malicious objectives. In some cases, for instance, these spam agents may represent automated software programs which submit meaningless responses to the tasks.

Among other drawbacks, the presence of low-quality work can quickly deplete the allocated financial resources of a task owner, without otherwise providing any benefits to the task owner.

### SUMMARY

According to one illustrative implementation, a crowdsourcing environment is described herein which uses a multi-stage approach to evaluate the quality of work performed by a worker, with respect to an identified task. In a first stage, an evaluation system determines whether the worker corresponds to a spam agent. The evaluation system invokes the second stage when the worker is determined to be a benign or “honest” entity, not a spam agent. In the second stage, the evaluation system determines the propensity of the worker to perform desirable work in the future. Desirability can be assessed in different ways; in one case, a worker who performs desirable work corresponds to someone who reliably provides accurate responses to the identified task. In another illustrative implementation, the evaluation system can perform spam analysis and quality analysis in a single integrated stage of processing.

According to one illustrative aspect, the evaluation system may operate based on a set of features which pertain to the work performed by the worker currently under consideration, with respect to the identified task. More specifically, the features may include worker-focused features, task-focused features, and system-focused features, etc.

Each worker-focused feature characterizes work performed by at least one worker in the crowdsourcing environment. For example, one kind of worker-focused feature may characterize an amount of work performed by a worker. Another worker-focused feature may characterize the accuracy of work performed by the worker in the past, and so on.

Each task-focused feature characterizes at least one task performed in the crowdsourcing environment. For example, one task-focused feature may characterize a susceptibility of the identified task to spam-related activity. Another task-focused feature may characterize an assessed difficulty level of the identified task, and so on.

Each system-focused feature characterizes an aspect of the overall configuration of the crowdsourcing environment. For example, one system-focused feature may describe an incentive structure of the crowdsourcing environment. Another system-focused feature may identify functionality (if any) employed by the crowdsourcing environment to reduce the occurrence of spam-related activity and low quality work.

Overall, at least some of the above-described features may correspond to meta-level features, each of which describes a context in which work is performed by the worker, but without specific reference to the work performed by the worker. For example, one kind of task-focused feature may correspond to a meta-level feature because it describes the identified task itself, without reference to work performed by the worker.

Further, at least some features may describe actual aspects of the crowdsourcing environment, e.g., corresponding to components, events, conditions, etc. Other features may correspond to belief-focused features, each of which pertains to a perception, by a worker, of an actual aspect of the crowdsourcing environment. For example, at least one belief-focused feature describes a perception by the worker of a susceptibility of the identified task to spam-related activity, and/or an ability of the crowdsourcing environment to detect the spam-related activity.

According to another illustrative aspect, at least the quality analysis operates using one or more models. A training system may produce the model(s) using any type of supervised machine learning technique. In one implementation, the quality analysis may use a plurality of task-specific models, each for analyzing work performed with respect to a particular task or task type. In another implementation, the quality analysis may use at least one task-agnostic model, together with meta-level features, for analyzing work performed with respect to plural different tasks and task types.

The above approach can be manifested in various types of systems, devices, components, methods, computer readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an illustrative crowdsourcing environment which uses a single-stage or multi-stage approach to evaluate work performed by workers.

FIG. 2 shows computer-implemented equipment that may be used to implement the crowdsourcing environment of FIG. 1.

FIG. 3 shows one implementation of a worker evaluation system, which is a component of the crowdsourcing environment of FIG. 1.

FIG. 4 shows a graphical model, representing one way to express a relationship among variables in the crowdsourcing environment of FIG. 1.

FIG. 5 shows illustrative characteristics associated with the crowdsourcing environment of FIG. 1, including worker-focused characteristics, task-focused characteristics, and system-focused characteristics.

FIGS. 6-8 show three respective implementations of a reputation evaluation module, which is a component of the worker evaluation system of FIG. 3.

FIG. 9 is a flowchart that shows one illustrative manner of operation of the worker evaluation system of FIG. 3.

FIG. 10 is a flowchart that shows one manner of operation of a feature extraction system, which is a component of the crowdsourcing environment of FIG. 1.

FIG. 11 is a flowchart that shows one manner of operation of a training system, which is another component of the crowdsourcing environment of FIG. 1.

FIG. 12 shows illustrative computing functionality that can be used to implement any aspect of the features shown in the foregoing drawings.

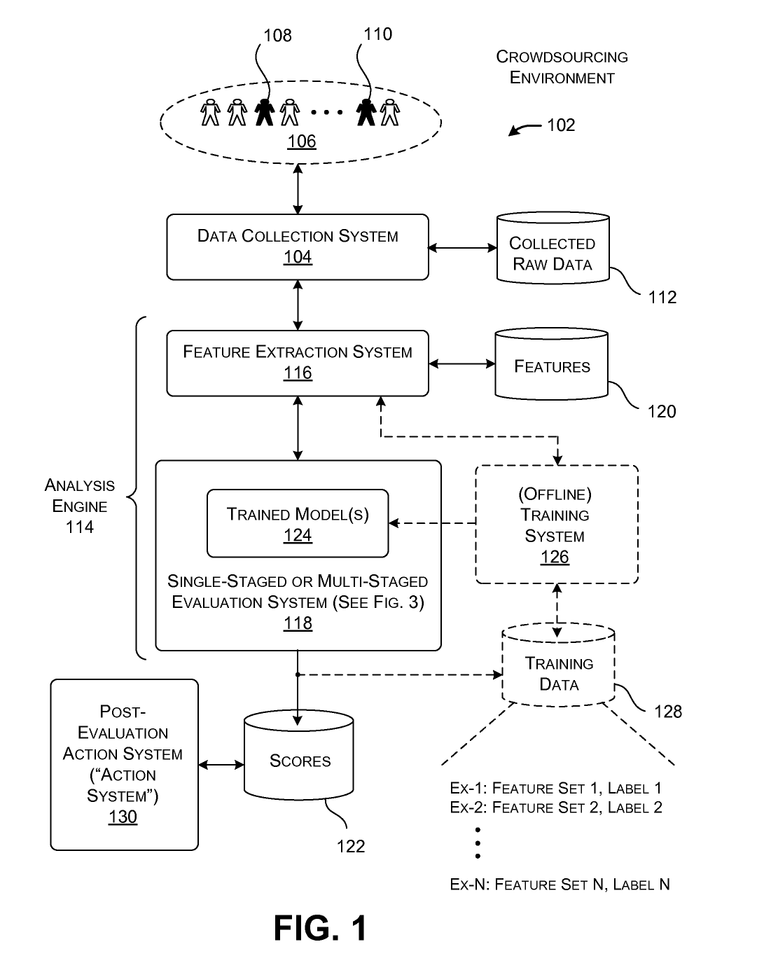

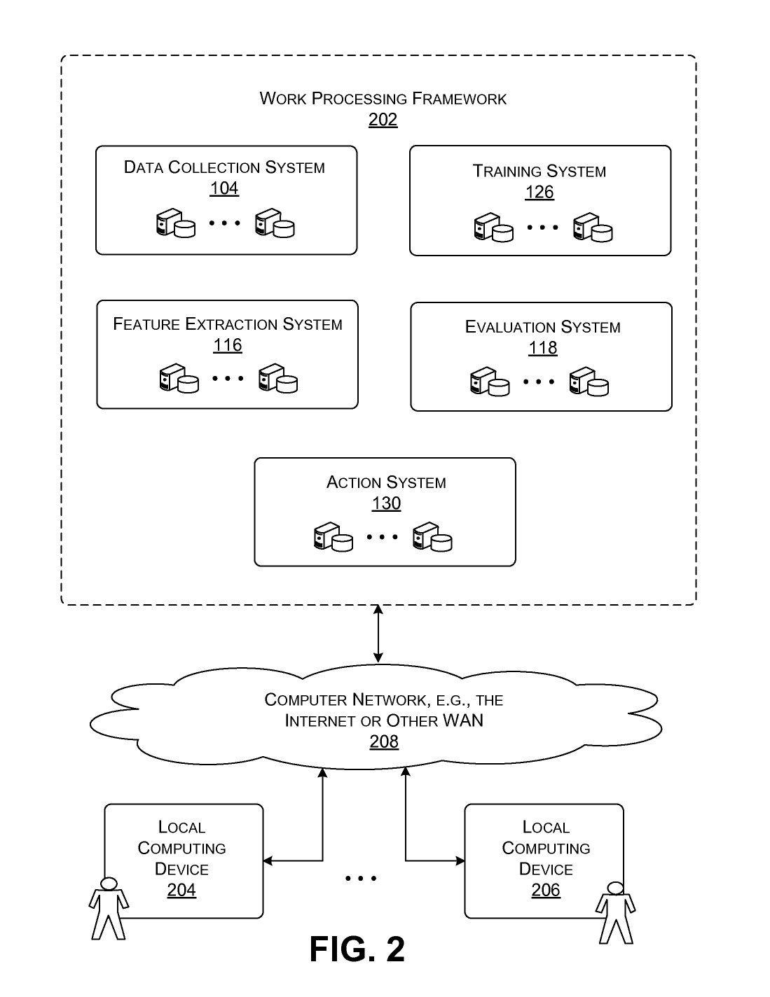

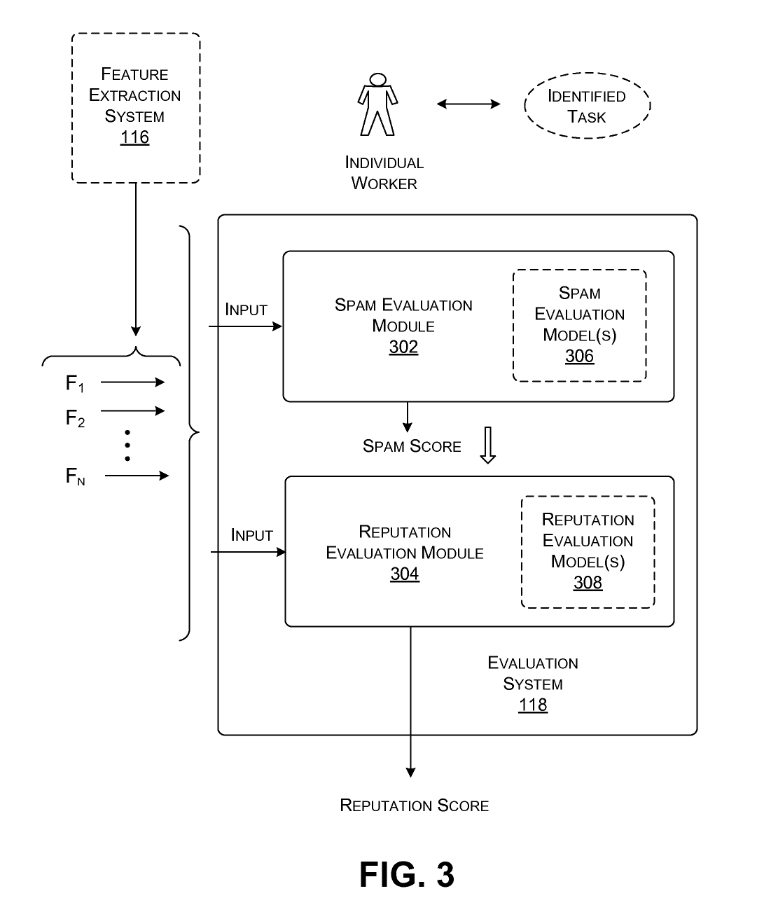

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes illustrative functionality for evaluating the quality of work performed by workers in a crowdsourcing environment, reflecting the propensity of the workers to perform the same quality work in the future. Section B sets forth illustrative methods which explain the operation of the functionality of Section A. Section C sets forth a sampling of representative features that may be used to describe the crowdsourcing environment. Section D describes illustrative computing functionality that can be used to implement any aspect of the features described in Sections A-C.

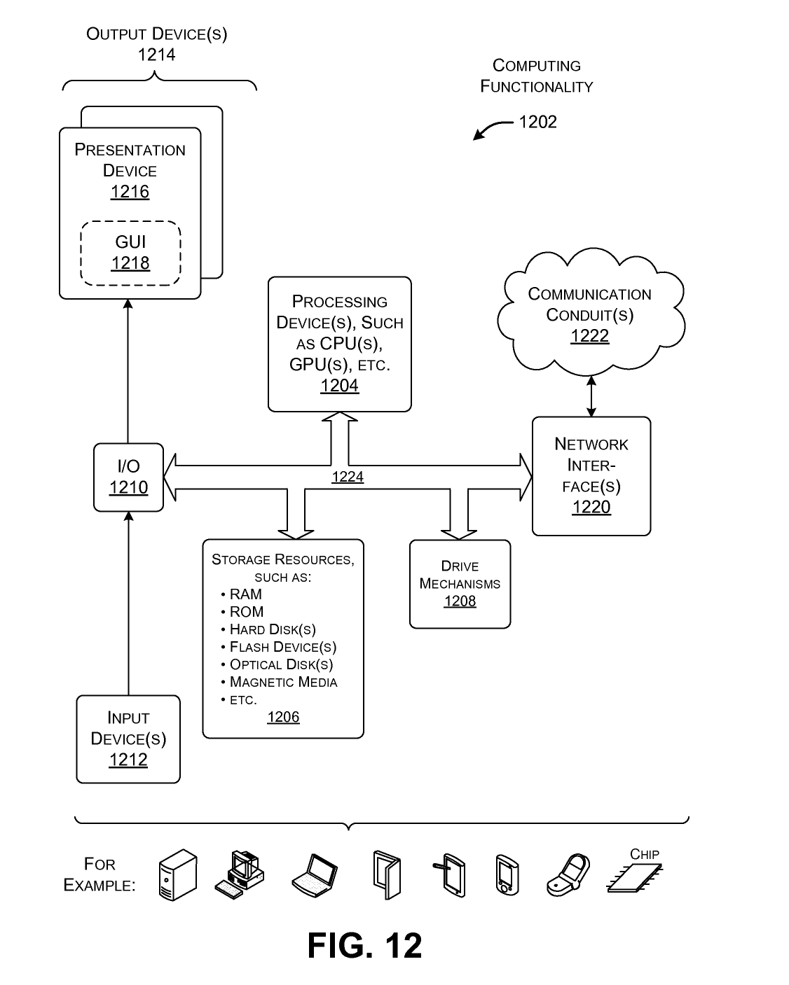

As a preliminary matter, some of the figures describe concepts in the context of one or more structural components, variously referred to as functionality, modules, features, elements, etc. The various components shown in the figures can be implemented in any manner by any physical and tangible mechanisms, for instance, by software running on computer equipment, hardware (e.g., chip-implemented logic functionality), etc., and/or any combination thereof. In one case, the illustrated separation of various components in the figures into distinct units may reflect the use of corresponding distinct physical and tangible components in an actual implementation. Alternatively, or in addition, any single component illustrated in the figures may be implemented by plural actual physical components. Alternatively, or in addition, the depiction of any two or more separate components in the figures may reflect different functions performed by a single actual physical component. FIG. 12, to be described in turn, provides additional details regarding one illustrative physical implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented in any manner by any physical and tangible mechanisms, for instance, by software running on computer equipment, hardware (e.g., chip-implemented logic functionality), etc., and/or any combination thereof.

As to terminology, the phrase “configured to” encompasses any way that any kind of physical and tangible functionality can be constructed to perform an identified operation. The functionality can be configured to perform an operation using, for instance, software running on computer equipment, hardware (e.g., chip-implemented logic functionality), etc., and/or any combination thereof.

The term “logic” encompasses any physical and tangible functionality for performing a task. For instance, each operation illustrated in the flowcharts corresponds to a logic component for performing that operation. An operation can be performed using, for instance, software running on computer equipment, hardware (e.g., chip-implemented logic functionality), etc., and/or any combination thereof. When implemented by computing equipment, a logic component represents an electrical component that is a physical part of the computing system, however implemented.

The following explanation may identify one or more features as “optional.” This type of statement is not to be interpreted as an exhaustive indication of features that may be considered optional; that is, other features can be considered as optional, although not explicitly identified in the text. Further, any description of a single entity is not intended to preclude the use of plural such entities; similarly, a description of plural entities is not intended to preclude the use of a single entity. Finally, the terms “exemplary” or “illustrative” refer to one implementation among potentially many implementations.

A. Illustrative Crowdsourcing Environment

FIG. 1 shows a logical view of a crowdsourcing environment 102. The crowdsourcing environment includes, or may be conceptualized as including, one or more modules that perform different respective functions. Different physical implementations can use different computer-implemented systems to carry out the functions, as will be described below with reference to FIG. 2.

To begin with, a data collection system 104 supplies tasks to a plurality of participants, referred to herein as workers 106. More specifically, in one case, the data collection system 104 can use a computer network to deliver the tasks to user computer devices (not shown) associated with the respective workers 106. The data collection system 104 can use a pull-based strategy, a push-based strategy, or a combination thereof to distribute the tasks. In a pull-based strategy, each individual worker interacts with the data collection system 104 to request a task; in response, the data collection system 104 forwards the task to the worker. In a push-based strategy, the data collection system 104 independently forwards tasks to the workers 106 based on some previous arrangement, without receiving individual independent requests by the workers 106.

A “task,” as the term is used herein, may correspond to specified unit of work that is assigned to a worker. For example, in one illustrative task, a worker may be presented with two data items, and asked to choose which data item is better based on any specified selection factor(s). In another illustrative task, a worker may be presented with a multiple choice question, and asked to choose the correct answer among the specified choices. In another illustrative task, a user may be asked to provide a response to a question or problem in an open-ended manner, that is, in a manner that is not confined to a specified set of answers. In another illustrative task, a worker may be asked to interpret an ambiguous data item, and so on. The above examples are cited by way of example, not limitation.

A “task type” pertains more generally to a general a class of activities that have one or more common characteristics. In other words, a task type may refer to a task template that can be used to produce different instantiations of a particular kind of task. For example, a task type may correspond to the general activity of judging which of two images is better based on identified selection factor(s). Different instantiations of this task type, corresponding to respective individual tasks, can be performed with respect to different pairings of images.

An entity which sponsors a task is referred to as the task owner. In some cases, the data collection system 104 only serves one owner, e.g., the entity which administers the entire crowdsourcing environment 102. In other cases, the data collection system 104 may represent a general platform, accessible to multiple task owners. That is, a task owner (not shown) may submit a task to the data collection system 104. The data collection system 104 may thereafter interact with the workers 106 to collect responses to the task.

A worker may perform a task in any environment-specific manner and task-specific manner. In many cases, for example, a worker may use his or her user computing device to receive the task, interpret the work that is being requested, perform the work, and then send his or her response back to the data collection system 104. To cite merely one illustrative example, assume that the task asks the user to select a search result item that is judged to be most relevant, with respect to a specified query. The worker may click on or otherwise select a search result item and then electronically transmit that selection to the data collection system 104. The data collection system 104 may optionally provide any type of reward to the worker in response to performing a task, based on any environment-specific business arrangement. In some cases, the reward may correspond to a monetary reward.

In the examples cited above, the workers 106 themselves correspond to human participants. The human participants may be members of the general public, and/or a population of users selected based on any factor or factors. In addition, or alternatively, at least some of the workers 106 may constitute automated agents that perform work, e.g., corresponding to software programs that are configured to perform specific tasks. For example, assume that one kind of task asks a user to translate a phrase in the English language to a corresponding phrase in the German language. A first worker may correspond to a human participant, while a second worker may correspond to an automated translation engine. Generally, the crowdsourcing system 102 can use different business paradigms to initially determine which workers 106 are permitted to work on tasks; in one case, in the absence of advance knowledge that a new worker has malicious intent, the crowdsourcing system 102 imposes no constraint on that new worker participating in a crowdsourcing campaign.

Indeed, the great majority of the workers 106 may prove to be benign or honest entities who are attempting to conscientiously perform the task that is given to them. Nevertheless, as in any workplace, some workers may perform the task in a more satisfactory fashion than others. Here, the desirability of a worker's response can be gauged based on any metric or combination of metrics. In many cases, a worker is judged mainly based on the accuracy of his or her responses. That is, a high-quality worker has the propensity to provide a high percentage of accurate responses, while a low-quality worker has the propensity to provide a low percentage of accurate responses.

But other factors, in addition to, or instead of, accuracy may be used to judge the desirability of workers. For example, in one scenario, the questions posed to the workers may have no canonically correct answers. In that case, a desirable response may be defined as an honest or truthful response, meaning a response that matches the user's actual subjective evaluation of the question. For example, assume that the user chooses an image among a set of images, with a claim that this image is most appealing to him or her; the user answers truthfully when the selected image is in fact the most appealing image to him or her, from the user's standpoint.

A subclass of workers 106 may, however, correspond to spam agents. A spam agent refers to any entity that performs low-quality work for a malicious purpose with respect to a task under consideration. For example, a spam agent may quickly generate a high volume of meaningless answers to at least some tasks for the sole purpose of generating fraudulent revenue from the crowdsourcing environment 102. In other (less common) cases, the spam agent may submit meaningless work for the primary purpose of skewing whatever analysis is to be performed based on the responses collected via the crowdsourcing environment 102. In FIG. 1, workers 108 and 110 symbolically represent two representative spam agents. In some cases, an entity may act as a spam agent with respect to some tasks under consideration, but not others. The selectiveness of the entity with respect to a particular task may depend on the nature of a task itself and/or one or more factors associated with the context in which the task is presented. In other cases, an entity may act as a spam agent for all tasks, in all circumstances.

In some cases, a spam agent may represent a human participant who is manually performing undesirable work as fast as possible. In other cases, a spam agent may represent a human participant who is commandeering any type of software tool to perform the undesirable work. In other cases, a spam agent may correspond to a wholly automated program which performs the undesirable work. For example, a spam agent may represent a bot computer program that is masquerading as an actual human participant. In some cases, the bot computer program may reside on a user computing device as a result of a computer virus that has infected that device.

Whatever its identity and origin, a spam agent is an undesirable actor in the crowdsourcing environment 102. In many cases, a spam agent may waste the allocated crowdsourcing budget of a task owner, without otherwise providing any benefit to the task owner. More directly stated, the spam agent is effectively stealing money from the task owner. In addition, or alternatively, the spam agent produces noise in the responses collected via the crowdsourcing environment 102, which may distort whatever analysis that the task owner seeks to perform on the basis of the responses. Indeed, in some cases, multiple spam agents may work together, either through willful collusion or happenstance, to falsely bias a determination of a consensus for a task.

The data collection system 104 may store the responses by the workers 106 in a data store 112. (As used herein, the singular term “data store” refers to one or more underlying physical storage mechanisms, provided at one site or distributed over plural sites.) The responses constitute raw collected data, insofar as the data has not yet been analyzed. For example, the raw data may include the workers' answers to multiple choice questions. The raw data may also specify the amounts of time that the workers 106 have spent to answer the questions, and so on.

An analysis engine 114 determines the propensity of each worker to provide desirable work, based on the prior behavior of that worker and other factors. Again, the desirability of work can be gauged in any manner; for example, in one case, a worker provides desirable work when he or she provides a high percentage of accurate and/or truthful responses to tasks.

In one case, the analysis engine 114 performs analysis on all workers who have previously contributed to the crowdsourcing environment 102. Or the analysis engine 114 can perform analysis for a subset of those workers, such as those workers who have an activity level above a prescribed threshold, and/or those workers who have recently contributed to the crowdsourcing environment, e.g., within an identified window of time. The analysis engine 114 can also performs its analysis with respect to all tasks (or task types) or just a subset of the tasks (or task types), selected on any basis. As to timing, the analysis engine 114 can perform its analysis on any basis, such as a periodic basis, an event-driven basis, or any combination thereof. In one event-driven case, for instance, the analysis engine 114 can performed its analysis in real time, e.g., after each worker has submitted a response to a task, or even part of a task.

The analysis engine 114 may include a feature extraction system 116 in conjunction with a worker evaluation system 118. The feature extraction system 116 identifies features which describe work performed by each particular worker, with respect to each particular task, together with the context in which the work has been performed. As will be set forth below, the feature extraction system 116 may produce different feature types that focus on different parts or aspects of the crowdsourcing environment 102, including, for instance, at least worker-focused features, task-focused features, and system-focused features, etc. Each worker-focused feature characterizes work performed by at least one worker in the crowdsourcing environment 102. Each task-focused feature characterizes at least one task performed in the crowdsourcing environment 102. Each system-focused feature characterizes an aspect of the overall configuration of the crowdsourcing environment 102. The following explanation will provide examples of each type of feature. Overall, at least some of the above-described features may also correspond to meta-level features that describe the context in which the worker is being evaluated, without explicit regard to the work performed the worker. For example, at least some meta-level features may describe characteristics of the task (or task type) itself. The feature extraction system 116 may store the extracted features in a data store 120.

The above-described features pertain to factual aspects of the crowdsourcing environment 102. For example, a system-focused feature may describe a particular response profile of a task, e.g., indicating that most workers choose option A rather than option B when responding to the task. Other features may pertain to a worker's subjective perception of an aspect of the crowdsourcing environment 102. These features are referred to herein as belief-focused features. For example, a particular belief-focused feature may describe the user's knowledge of a response profile of a task, or subjective reaction to the response profile.

The worker evaluation system 118 generates a reputation score based on the features. The reputation score reflects the propensity of the worker to perform desirable work in the future. In one case, the worker evaluation system 118 generates the reputation score using two or more stages. More specifically, in one implementation, in a first stage of spam analysis, the worker evaluation system 118 can determine a spam score for the worker that indicates whether the worker under consideration constitutes a spam agent. The worker evaluation system 118 may perform a second stage when the worker is determined to be an honest (non-spam) worker. In the second stage of quality analysis, the worker evaluation system 118 can determine a reputation score for the worker. In another implementation, the evaluation system 118 can perform its spam analysis and quality analysis in a single stage of processing.

More specifically, in one case, the evaluation system 118 can generate a spam score for each worker for each task (or each task type) under consideration. In addition, or alternatively, the evaluation system 118 can compute an overall spam score for a worker for all tasks, e.g., by averaging the individual reputation scores for that worker for different respective tasks (or task types), or taking the lowest reputation score as the representative spam score of the worker. Similarly, the evaluation system 118 can compute a reputation score for each worker and each task under consideration, and/or an overall reputation score for the worker for all tasks. A data store 122 may store the scores produced by the evaluation system 118, including the spam scores and the reputation scores.

The evaluation system 118 can perform the above operations based on one or more models 124. The model(s) 124 convert the input features into the output scores (e.g., the spam score and the reputation score) for a worker and task under consideration. In one case, a training system 126 may produce the model(s) by applying a supervised machine learning process, based on labeled training data in a data store 128. More specifically, the training system 126 produces a model of any type or types, including, but not limited to: a linear model that computes a weighted sum of features, a decision tree model, a random forest model, a neural network, a clustering-based model, a probabilistic graphical model (such as a Bayesian hierarchical model), and so on. In addition, any boosting techniques can be used to produce the models. A boosting technique operates by successively learning a collection of weak learners, and then producing a final model which combines the contributions of the individual weak learners. The boosting technique adjusts the weights applied to the training data at each iteration, to thereby place focus on examples that were incorrectly classified in a prior iteration of the technique.

A post-evaluation action system 130 (“action system” for brevity) performs some action based on the spam and/or reputation scores generated by the evaluation system 118. In one case, the action system 130 can prevent a worker from receiving additional tasks based on his or her score(s), e.g., based on the assumption that the worker constitutes a spam agent, or the belief that the worker constitutes an honest entity having a low aptitude for performing the identified tasks. More specifically, the action system 130 may outright bar the worker for all time; or the action system 130 may suspend the worker for a defined time-out period. Alternatively, or in addition, the action system 130 can throttle the amount of work that the worker is allowed to perform based on his or her score(s), without outright excluding the worker from performing work. Alternatively, or in addition, the action system 130 can place the worker under heightened future scrutiny based on his or her score(s). Alternatively, or in addition, the action system 130 can proactively route tasks to the worker for which he or she has the greatest proven proficiency, based on his or her score(s).

Alternatively, or in addition, the action system 130 can inform the worker of his or her score(s) with respect to identified tasks or all tasks. Alternatively, or in addition, the action system 130 can send a warning message to the worker if warranted by his or her score(s), and/or notify appropriate authorities of potential malicious conduct by the worker. Alternatively, or in addition, the action system 130 can use the worker's score(s) as one factor in calculating the rewards given to the worker, based on the premise that a high quality worker deserves a greater reward (e.g., a bonus) compared to a low quality worker. Alternatively, or in addition, the action system 130 can provide some type of non-monetary prize to worker on the basis of his or her score(s), such as by designating the worker as a “worker-of-the-month,” and/or publicizing the worker's accomplishments on a computer-accessible leader board or the like, etc.

Alternatively, or in addition, the action system 130 can use a worker's score(s) to determine a level of confidence associated with that worker's responses to a task. The action system 130 can use the confidence level, in turn, to weight the worker's response when computing various aggregate work measures, such as when forming a consensus measure or the like. In such an approach, a response by a worker with a high reputation score will exert more influence in the consensus than a response by a worker with a lower reputation score.

The above-stated post-evaluation operations are described by way of example, not limitation; the action system 130 may perform yet additional operations, not mentioned above.

FIG. 2 shows computer-implemented equipment that may be used to implement the crowdsourcing environment 102 of FIG. 1. The equipment includes a work processing framework 202 for implementing the data collection system 104, the feature extraction system 116, the evaluation system 118, the training system 126, and the action system 130. Each of the systems (104, 116, 118, 126, 130) may correspond to one or more server computing devices in conjunction with one or more storage mechanisms and/or other data processing equipment (such as routers, load balancers, etc.).

In one case, a single entity implements all of the systems (104, 116, 118, 126, 130) of the work processing framework 202 at a single site, or in a distributed manner, over plural sites. In another case, two or more entities may implement respective parts of the work processing framework 202. For example, a first entity may implement the data collection system 104. A second entity may implement the remaining components of the work processing framework 202. That is, the second entity may utilize the separate services of the data collection system 104 to collect responses from the workers 106. The second entity may process the responses with the remaining components of the work processing framework 202, e.g., by generating one or more models based on the responses, and then applying those models in a real-time phase of operation.

Each worker may interact with the data collection system 104 via a respective user computing device of any type. For example, a first worker uses a first local computing device 204, a second worker uses a second computing device 206, and so on. Illustrative types of user devices may include, but are not limited to: a desktop computing device, a laptop computing device, a game console device, a set-top box device, a tablet-type computing device, a smartphone, a media consumption device, a wearable computing device, and so on. Further, in some implementations, the action system 130 may interact with the workers via their respective user computing devices. For example, the action system 130 may notify the workers of their reputation scores via their devices.

At least one computer network 208 may couple the workers' user computing devices with the components of the work processing framework 202. In some implementations, the components of the work processing framework 202 may also interact with each other via the computer network 208. The computer network 208 may correspond to a local area network, a wide area network (e.g., the Internet), point-to-point links, or some combination thereof.

In some implementations, the work processing framework 202 is entirely implemented by centrally-disposed computing and storage resources, which are provided at one or more locations that are remote with respect to the location of each worker. For example, the work processing framework 202 may be provided by at least one data center, and the workers may correspond to members of the public who are geographically dispersed over a wide area. In another case, the work processing framework 202 may be provided by one or more servers of a company's enterprise system, and the workers may correspond to employees of that company. Still other centrally-disposed implementations having different respective scopes are possible. In other implementations, one or more local computing devices can perform one or more aspects of the work processing framework 202. For example, one or more local computing devices can compute at least some of the features, and then forward those features to remotely-located components of the work processing framework 202. The local computing device(s) may correspond to the user (client) computing devices (e.g., devices 204, 206) used by the workers, and/or any other computing devices provided in proximity to the respective workers (such as separate monitoring devices which monitor the work performed by the workers).

FIG. 3 shows one implementation of the evaluation system 118. In the context illustrated there, the evaluation system 118 generates a reputation score for a particular worker under consideration, with respect to an identified task (or task type).

In one implementation, the evaluation system 118 includes a spam evaluation module 302 and a reputation evaluation module 304. The spam evaluation module 302 generates a spam score, which reflects the likelihood that the worker corresponds to a spam agent, with respect to the identified task (or task type). The spam evaluation module 302 may use at least one spam evaluation model 306 to perform its operation. The spam evaluation model 306 operates by generating the spam score based on a plurality of input features (described below).

The reputation evaluation module 304 generates a reputation score, which reflects the propensity of the worker to perform desirable (e.g., accurate) work for the task (or task type) under consideration. The reputation evaluation module 304 may use at least one reputation evaluation model 308 to perform that operation. The reputation evaluation model 308 operates by generating the reputation score based on a plurality of input features (described below). The spam score, generated by the spam evaluation model 302, may correspond to one input feature received by the reputation evaluation model 308.

The spam evaluation model 306 may correspond to at least one model that is produced in an offline supervised machine-learning process, or based on some other model-generating technique. Likewise, the reputation evaluation model 308 may correspond to at least one model that is produced in an offline supervised machine-learning process, or based on some other model-generating technique. Section B provides additional details regarding a training operation that may be used to produce the models (306, 308).

The evaluation system 118 depicted in FIG. 3 constitutes a multi-stage system in which the spam evaluation module 302 operates first, followed by the reputation evaluation module 304 (providing that the spam evaluation module 302 indicates that the worker is not a spam agent). In another implementation, the evaluation system 118 uses an integrated module to generate the spam score and the reputation score for a worker and task under consideration. That single module may use one or more models produced offline in a supervised machine learning process, and/or by some other technique.

More generally, in the following explanation, the evaluation system 118 is said to perform its analyses on individual tasks or task types; however, to simplify explanation, the parenthetical phrase “(or task type)” will not be explicitly stated in each case. In other words, in some implementations, the evaluation system 118 may perform its analysis on a task by performing analysis on a task type to which the task belongs, although this is not always explicitly stated.

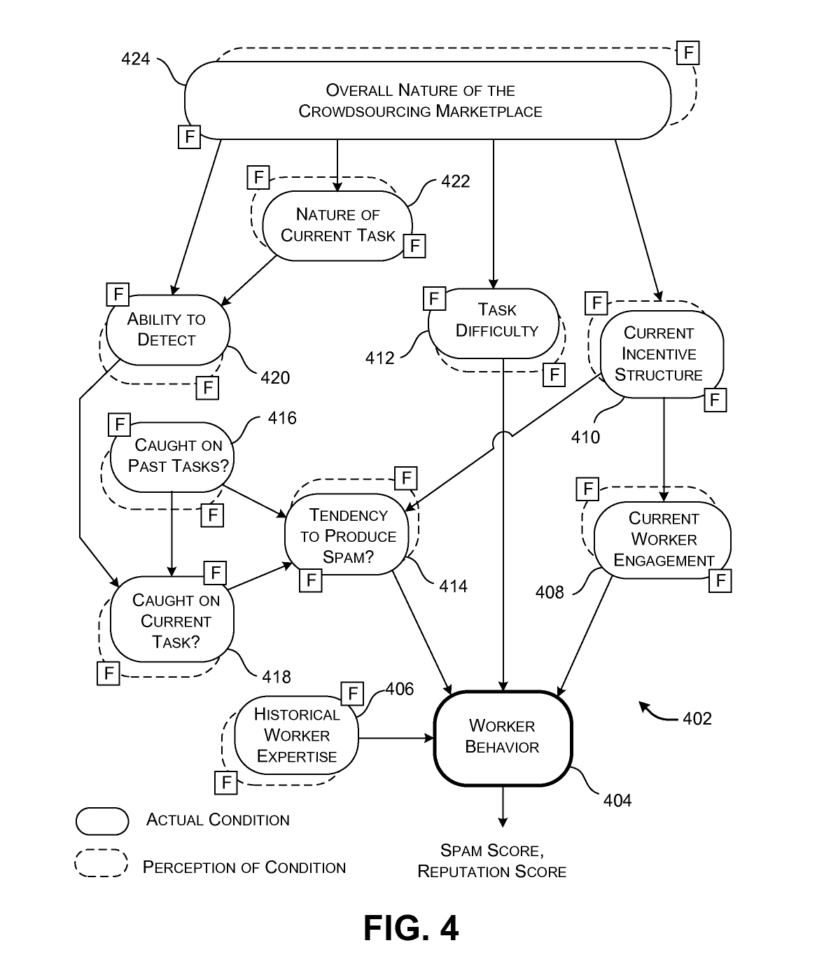

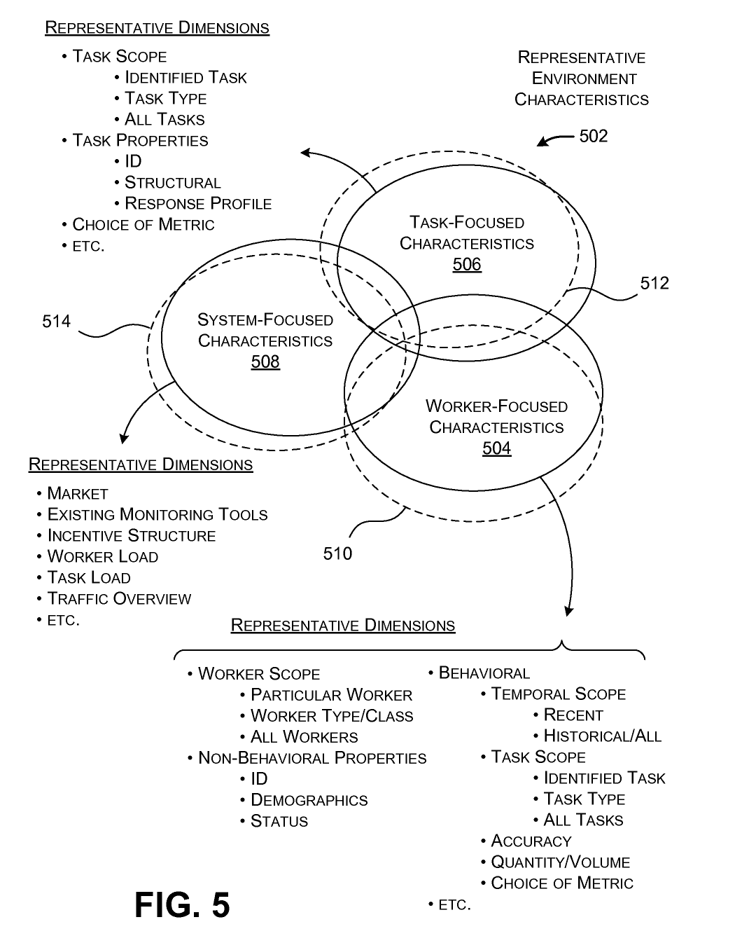

Now advancing to FIGS. 4 and 5, these figures describe one manner by which the feature extraction system 116 may characterize the crowdsourcing environment 102 using a set of features. As noted above, the evaluation system 118 accepts these features as input signals. Note that the features described below are set forth by way of example, not limitation; other implementations can use sets of features which differ in any respect from the features described below.

Starting with FIG. 4, this figure shows a probabilistic graphical model 402 which describes how different variables in the crowdsourcing environment 102 may influence the computation of a worker's spam score and reputation score. In one implementation, the evaluation system 118 generates scores using the graphical model 402 itself. In another case, the evaluation system 118 generates the scores based on some other model; nevertheless, even in this case, the graphical model 402 serves as a useful tool for explaining the different features that may be fed to the evaluation system 118.

More specifically, FIG. 4 includes a plurality of nodes that represent different aspects of the crowdsourcing environment 102. For instance, the nodes that are drawn in solid lines reflect actual components, events, conditions, etc. in the crowdsourcing environment 102. These nodes are referred to herein as actual-aspect nodes. The arrows that connect the actual-aspect nodes together represent possible dependencies among actual-aspect variables. These relationships are to be understood as representative of one particular environment, involving a particular set of system components, workers, and tasks. Other environmental settings may exhibit other dependencies among actual-aspect nodes. Generally, in one implementation, a model developer may manually define the relationships among the nodes in the graphical model 402, e.g., based on his or her insight into the nature of the crowdsourcing environment 102. Alternatively, or in addition, the machine-learning training operation may provide insight into the relationships among the nodes, and the levels of importance of the nodes.

Each node drawn in broken lines represents a worker's belief or perception of a particular aspect of the crowdsourcing environment 102. Each such node is referred to herein as a belief-focused node. For example, as will be described below, one actual-aspect node in FIG. 4 reflects the existence of functionality in the crowdsourcing environment 102 that is intended to detect spam-related activity. A complementary belief-focused node (drawn in broken lines in proximity to the corresponding actual-aspect node) reflects a particular worker's knowledge that the system is using the identified functionality to detect spam-related activity.

In any particular environmental setting, there is also a nexus between belief-focused variables and other belief-focused variables, and between belief-focused variables and actual-aspect variables. Any kind of statistical model, such as the type of probabilistic graphical model shown in FIG. 4, may mathematically express these relationships. A visual depiction of such a model will therefore include: arrows connecting belief-focused nodes (associated with a user's beliefs and perceptions of state) with other belief-focused nodes; arrows connecting belief-focused nodes with actual-aspect nodes; and arrows connecting actual-aspect nodes with other actual-aspect nodes. However, so as not to produce an unduly cluttered depiction, FIG. 4 omits a depiction of the relationships that pertain to a user's beliefs and perceptions. Nevertheless, the following explanation will provide some examples of possible dependencies involving belief-focused nodes.

FIG. 4 will be explained in generally bottom-up fashion. To begin with, a node 404 represents one or more variables that describe the behavior of a worker. That worker behavior, in turn, can be expressed using the spam score and the reputation score for the worker, which may be computed using a single-stage model or a multi-stage model. As set forth above, other nodes in the graphical model 402 represent other variables, describing respective other aspects of the crowdsourcing environment 102, some pertaining to actual aspects, and others pertaining to the beliefs of a worker under consideration. These other variables directly or indirectly feed into the node 404, indicating that the corresponding aspects of the crowdsourcing environment 102 either directly or indirectly influence the worker's behavior.

For instance, an actual-aspect node 406 reflects the historical expertise or skill level of the worker under consideration with respect to an identified task or tasks. The expertise of the worker may manifest itself in the accuracy at which the worker has answered a particular task (or tasks) on prior occasions. In addition, or alternatively, the expertise of the worker may correlate to the length of time at which the worker has been responding to the particular type of task or tasks under consideration, the number of days that the worker has been active overall, and so on. Generally, the expertise of the worker can be expected to exert a positive influence on the worker's reputation score, such that higher-skilled workers will have higher reputation scores compared to lower-skilled workers; the spam score of the worker, on the other hand, can be expected to decrease with an increase in the worker's level of expertise. A belief-focused counterpart of this node 406 may describe the worker's perception of his or her own skill level.

An actual-aspect node 408 is associated with one or more variables which reflect the worker's current engagement with a task (or tasks) under consideration. In other words, this node 408 reflects the activity level of the worker in some recent timeframe, e.g., as reflected by the task or tasks that the user has just completed, or the user's activity in a current crowdsourcing session, or the user's activity over the course of the current day, etc. In part, the worker's current engagement may be exhibited by the amount of time that the worker has most recently spent on a particular task (e.g., the user's dwell time), the number of tasks that the user has completed in a recent timeframe (e.g., in the current day), a comparison of the user's current activity level with that of others, and so on. In many cases, a worker who answers tasks very quickly (relative to some specified norm), and/or who answers a large number of tasks in a short period of time (relative to some specified norm), may correspond to a low-quality worker or a spam agent, justifying a low reputation score and a high spam score. A subjective belief-focused counterpart to this node 408 may reflect a worker's perception of his own level engagement relative to others, etc.

Different factors may influence the worker's engagement with a task, such as the current incentive structure of the crowdsourcing environment 102, which is reflected by the variable(s) associated with the actual-aspect node 410. More specifically, the incentive structure defines the type and size of the rewards (if any) that the crowdsourcing environment 102 gives to its workers upon completing tasks, as well the conditions under which those rewards are given. An incentive structure that provides relatively larger rewards, and/or which provides for relatively frequent rewards, can be expected to increase the worker's engagement with tasks. A counterpart belief-focused node may describe an extent to which the worker understands the incentive structure of the crowdsourcing environment 102, particularly when there are ways to “game” the incentive structure that may not be readily apparent to all workers.

An actual-aspect node 412 is associated with one or more variables which reflect the difficulty or complexity of a task under consideration. The complexity of the task can influence worker behavior in different ways. For example, the complexity level of a task may spotlight the respective strengths and weakness of a worker under consideration, e.g., as reflected by whether the user is able to correctly answer the task. And for this reason, the complexity level of the task can be said to be correlated with the reputation-related behavior of the worker.

Further, a spam agent may be more able to exploit a “simple” task compared to a more sophisticated task. For this reason, the complexity of a task can be said to also influence the spam-related behavior of the worker under consideration. For example, a task that requires a simple selection between two binary choices may represent a more vulnerable target compared to a task that requires a worker to enter a complex sequence of inputs, especially where that sequence of inputs varies upon each presentation of an instance of the task. In other words, a bot may be able to successfully mimic the kind of responses demanded by the first kind of task, but not the second kind of task. For a spam agent, a belief-focused counterpart to the node 412 may measure an extent to which a worker understands how the difficulty level of a task can be leveraged to exploit the task.

An actual-aspect node 414 is associated with one or more variables that reflect the proclivity of the worker to produce spam or low-quality responses. Different factors in the crowdsourcing environment 102, may, in turn, contribute to this factor. For example, a current incentive structure (as reflected by node 410) that offers large and/or frequent rewards can be expected to encourage spam agents (as well as honest workers) to perform a large quantity of tasks. On the other hand, a spam agent may forego its fraudulent activity when there is little or no financial reward. Nevertheless, even for low-paying tasks, some spam agents may still be driven by other malicious objectives, such as a desire to sabotage the normal operation of the crowdsourcing environment 102. A counterpart belief-focused node may reflect a worker's awareness that their behavior is being classified as spam-related in nature.

An actual-aspect node 416 indicates whether the worker under consideration has been previously caught in the act of submitting spam in the crowdsourcing environment 102. An actual-aspect node 418 indicates the likelihood that the worker under consideration will be currently caught engaging in spam-like activity, e.g., in the current transaction. Such a status, reflecting either current activity or prior activity, influences the likelihood that the worker, on a present occasion, should be formally labeled as a spam agent. In other words, the variables associated with nodes 416 and 418 contribute to the conclusion reflected by node 414.

A belief-focused counterpart to the node 416 may reflect a worker's knowledge that his or her spam-like activity has actually been detected on prior occasions. A belief-focused counterpart to the node 418 reflects a worker's perception of the likelihood that he or she will be caught committing spam-like activity in a current transaction

An actual-aspect node 420 reflects an ability of the crowdsourcing environment 102 to detect a spam agent's spam-related activity. A counterpart belief-focused node may describe the worker's sense of the ability of the crowdsourcing environment 102 to detect the worker's undesirable activity. As illustrated in FIG. 4, the actual ability of the environment 102 to detect spam may influence the likelihood that the worker will actually commit spam (reflected by the actual-aspect node 418). Although not shown in FIG. 4, the worker's perception of the environment's ability to detect spam will also likely influence his or her subjective evaluation that he or she will be caught committing spam in the current transaction. And the user's belief in this regard may also influence the actual likelihood that the user will commit spam (again, as reflected by the node 418). This is an example of one possible nexus between two belief-focused nodes, and between a belief-focused node and an actual-aspect node. As stated above, FIG. 4 generally omits these relationships to facilitate illustration, and because these relationships are environment-specific in nature (meaning that they are not fixed, and may vary for different settings).

The environment's ability to detect spam, as reflected by the actual-aspect node 420, may, in turn, depend on one or more other factors. For example, as noted above, some tasks lend themselves to exploitation by spammers more than others. FIG. 4 reflects the objective spam-susceptibility of the current task by an actual-aspect node 422. For example, consider a first kind of task that offers a binary choice between two options. Further assume that the response profile of that task is biased toward one of the options (e.g., choice “A”). In that scenario, a spam agent can potentially automatically submit a large number of responses for choice “A” without distinguishing itself from honest workers. In contrast, consider a task that demands a freeform answer, a complex series of interactions, etc. A spam agent's meaningless answers to this type of question will be much more readily apparent compared to the first type of task.

A counterpart belief-focused node, pertaining to the actual-aspect node 422, may reflect the spam agent's ability to recognize that the current task is vulnerable to exploitation. For example, a spam agent that has knowledge of the response profile of the task may be in a more effective position to exploit it. The worker's knowledge in this regard can be assessed in different ways. For example, assume that the crowdsourcing environment 102 maintains statistical information regarding the response profile of a particular task. The worker's knowledge of this information may be gauged based on evidence that the worker has accessed this information, either through legitimate channels or surreptitiously. In other cases, the worker's understanding of the exploitability of a task may be indirectly inferred from his or her behavior towards different types of tasks having different respective structures.

The above explanation may be generalized to any belief-focused node. In some cases, the feature-extraction system 116 is able to extract direct evidence that the user knows or understands a particular piece of information, or has adopted a particular subjective stance or posture to that piece of information. In other cases, the worker's mental state can be indirectly inferred based on his or her behavior. Indeed, the environment 102 can even present tasks that are specifically designed to expose the mental state of the user, as it pertains to their propensity to perform spam-related work.

The actual ability to detect spam-related activity (as reflected in the actual-aspect node 420) may also depend on one or more actual features of the crowdsourcing environment 102 as a whole, as reflected by one or more variables associated with the actual-aspect node 424. For example, the node 424 reflects, in part, other measures that the crowdsourcing environment 102 may potentially use to detect and/or thwart spam agents and low-quality workers, independent of the analysis engine 114. For example, the node 424 may indicate whether the crowdsourcing environment 102 uses any supplemental functionality (e.g., a firewall, a virus protection engine, a spam detection engine, CAPTCHA interfaces, etc.) to independently reduce the prevalence of spam agents in the crowdsourcing system 102. The node 424 may also describe the policing and penalty provisions that the crowdsourcing environment 102 applies when it does detect a spam agent.

The top-level actual-aspect node 424 may also represent other aspects of the crowdsourcing environment 102 as a whole. These aspects may influence, in part, the nature of the tasks that are hosted by the crowdsourcing environment 102 (as reflected in actual-aspect nodes 412 and 422), the incentive structure of the crowdsourcing environment 102 (as reflected in actual-aspect node 410), and so on. The top-level node 420 may also provide an overview of the typical population of workers associated with the crowdsourcing environment 102, the collection of tasks hosted by the crowdsourcing environment 102, the market to which the crowdsourcing environment 102 is directed, the traffic load associated with the crowdsourcing environment 102, and so on.

For example, with respect to the above-described system-level factors, a crowdsourcing environment that caters to skilled workers (e.g., scientists, technicians, etc.) may exhibit less spam than a crowdsourcing environment open to the general public. Further, a crowdsourcing environment that requires a user to provide personal credentials before responding to tasks can be expected to exhibit less spam than a crowdsourcing environment that permits anonymous participation, and so on.

One or more counterpart belief-focused nodes may describe a worker's understanding and/or subjective response to any of the above-described objective factors associated with the actual-aspect node 424.

FIG. 4 shows that each of the above described nodes (404-424), and each of the counterpart belief-focused nodes, is annotated with the symbol “F”. That notation indicates that the feature extraction system 116 may formulate one or more features that describe each aspect of the crowdsourcing environment 102, associated with each respective actual-aspect node in FIG. 4, and each belief regarding the actual aspects, associated with each belief-focused node. To cite one example, consider the actual aspect node 412, which may represent the difficulty associated with an identified task. The feature extraction system 116 may generate a first feature which describes the number of answers associated with the task, which may serve as one proxy of the difficulty level of the task. The feature extraction system 116 may generate a second feature which describes the distribution of answers associated with the tasks which may serve as another proxy for level of difficulty. That is, a highly complex task can be expected to generate a wider distribution of answers compared to a simple task.

Although not shown in FIG. 4, the feature extraction system 116 may also identify features that describe the relationships among nodes. In another case, the feature extraction system 116 may only generate features associated with the nodes, not the relationships among the nodes. In the latter case, the training system 126 may nevertheless automatically discover relationships among the nodes during the training process, even though these relationships are not explicitly defined beforehand.

As a final comment with respect to FIG. 4, the above description was based on the assumption that the analysis engine 114 is performing real-time generation of spam scores and reputation scores as the workers interact with the crowdsourcing environment 102. In another case, as set forth above, the analysis engine 114 may perform its analysis on a non-real-time basis, e.g., on a periodic basis. In that case, the analysis engine 114 can define the “current” behavior of the user to correspond to the most recent activity of the user, whenever that occurred. In addition, or alternatively, the analysis engine 114 can define any prior time as the current time, and perform analysis with respect to that designated time.

FIG. 5 describes another way of representing different characteristics 502 of the crowdsourcing environment 102, compared to FIG. 4. As shown there, the crowdsourcing environment 102 can be expressed along at least three main descriptive axes, e.g., by conceptualizing the environment as having a collection of worker-focused characteristics 504, a collection of task-focused characteristics 506, and a collection of system-focused characteristics 508. In other words, FIG. 5 groups the variables associated with the nodes 404-424 in FIG. 4 into three main categories: a worker category, a task category, and a system category. Other characteristics (510, 512, 514) describe belief-focused characteristics, e.g., relating to a worker's perception of the corresponding actual work-focused, task-focused, and system-focused characteristics (504, 506, 508). Other characteristics (not shown) may describe the relationships among the above-described aspects.

Each worker-focused characteristic represents work performed by at least one worker in the crowdsourcing environment 102. For example, one worker-focused characteristic may represent an amount of current work performed by the worker. That characteristic may therefore relate to the variable(s) associated with the actual-aspect node 408 of FIG. 4. Another worker-focused characteristic may represent an historical accuracy of work performed by the worker. That characteristic may therefore pertain, in part, to the variable(s) associated with the actual-aspect node 406 of FIG. 4.

Each task-focused characteristic represents at least one task performed in the crowdsourcing environment 102. For example, one task-focused characteristic may represent an objective susceptibility of the identified task to exploitation by spammers. That characteristics may correspond the variable(s) associate with the actual-aspect node 422 of FIG. 4. Another task-focused characteristic may represent an assessed difficulty level of the identified task, and so on. That characteristic corresponds to the variable(s) associated with actual-aspect nodes 412 and 422 of FIG. 4.

Each system-focused characteristic represents an actual aspect of a configuration of the crowdsourcing environment 102. For example, one system-focused characteristic may describe an incentive structure of the crowdsourcing environment 102. That characteristic may pertain to the variable(s) associated with the actual-aspect node 410 of FIG. 4. Another system-focused characteristic may identify functionality (if any) employed by the crowdsourcing environment to reduce the occurrence of spam-related activity and low quality work. That characteristic may present the variable(s) associated with actual aspect node 424 of FIG. 4. Each of the above characteristics may have a subjective, belief-focused counterpart, in the manner described above with respect to FIG. 4.

FIG. 5 indicates that the three separate realms of actual characteristics may overlap, at least in part. For example, in describing the worker's engagement with an identified task, a worker-focused characteristic may also make reference to the nature of the task. But the primary focus of that feature is nevertheless on the work performed by the worker. On the other hand, a task-focused feature may attempt to capture the nature of a task by describing the manner in which workers have responded to the task. Although that task-focused characteristic makes reference to the behavior of the workers, its primary intent or focus is to describe the nature of the task, not to directly capture the behavior of any one worker. Similarly, the different belief-focused realms may intersect with each other, as well as intersect with the different actual-aspect realms.

Overall, at least some of the above-described characteristics may correspond to meta-level characteristics, each of which describes a context in which work is performed by the worker, but without making specific reference to the work performed by the worker. For example, one kind of task-focused characteristic may correspond to a meta-level feature because it describes the identified task itself, without reference to work performed by the worker.

A collection of worker-focused features may be used to express the actual-aspect worker-focused characteristics, a collection of task-focused features may be used to express the actual-aspect task-focused characteristics, and a collection of system-focused features may be used to express the actual-aspect system-focused characteristics. Sets of belief-focused features can be established in a similar way.

Further, a collection of meta-level features correspond to meta-level characteristics of the crowdsourcing environment 102. In some implementations, the training system 126 can use the meta-level features to produce at least one model that is applicable to many different tasks, not just a specific individual task. In other words, the use of meta-level features (in addition to the worker-focused features, etc.) serves to generalize the model(s) produced by the training system 126, making them adaptable to many different tasks, even new tasks that have not yet been applied to the crowdsourcing environment 102. Many meta-level features will describe the actual aspects of the crowdsourcing environment 102. But it is also possible to formulate some belief-focused meta-level features, such as by expressing a belief shared by most workers with respect to a particular task; that feature may be regarded as a meta-level feature because it is not narrowly focused on the behavior of any one worker, but rather, may serve as one more way to describe the task in general. In another words, such a feature describes an aggregate subjective response to the task.

Each individual feature may leverage one or more dimensions of a feature space in describing its characteristics. FIG. 5 enumerates representative dimensions for each respective category of features. First consider the collection of worker-focused features. A worker-focused feature may pertain to any worker-related scope, e.g., by identifying work performed a single worker, work performed by a type or class of workers, or work performed by all workers. In addition, or alternatively, a worker-focused feature may describe at least one non-behavioral property of a worker under consideration, such as the worker's ID, some aspect of the worker's demographic characteristics, the worker's spam-related status (and/or other status), etc.

In addition, or alternatively, a worker-focused feature may describe the behavior of a worker under with reference to any temporal scope, such as the most recent task (or tasks) completed by the worker, or a more encompassing span of time of previous worker activity. In addition, or alternatively, a worker-focused feature may describe the behavior of the worker in the context of any task scope, such as a specific task, a task type (e.g., associated with a task class to which a task belongs), all tasks, etc.

In addition, or alternatively, a worker-focused feature can describe the accuracy of the worker's response(s) with respect to any task or tasks. In addition, or alternatively, a worker-focused feature may describe the behavior of the worker in the context of the quantity of work performed by the worker, and so on.

In addition, or alternatively, a worker-focused feature can use any metric or metrics to express any of the characteristics set forth above. In some cases, the metric attempts to measure the identified behavior of the user without reference to any other behavior. For example, a worker-focused feature can express the worker's engagement with a current task by determining how long the worker has spent in replying to the task, measured from a point of time at which the worker commenced the task (and referred to as the dwell time). In other cases, the metric attempts to compare the worker's current behavior with the worker's prior behavior, measured over some span of time. In other cases, the metric attempts to compare the worker's behavior with respect to the behavior of other workers. In other cases, the metric attempts to compare one or more workers' behavior across different tasks, or with respect to tasks in a task class, and so on.

The metric itself can leverage any mathematical operation(s), such as average computation(s), variance computation(s), entropy computation(s), ratio computation(s), min and/or max computation(s), and so on. Further, in some cases, the evaluation system 118 can perform computations by first excluding the contribution of spam agents in an input data set under consideration.

Some metrics may also compare the worker's response to some standard of correctness, truthfulness, or some other expression of desirability. In a first case, the correct (or otherwise desirable) response to a task is defined beforehand. Such a standard may be metaphorically referred to as a gold standard, and the task to which it pertains may be referred to as a gold set task. In a second case, the correct (or otherwise desirable) response to a task is defined by the consensus of one or more workers.

Consensus, in turn, can be defined in any environment-specific way. In one case, a consensus among workers is considered to be established whenever the percentage of people who provide a particular response exceeds a prescribed threshold, providing that the total number of people who have performed the task also exceeds another prescribed threshold. Further, in some implementations, the feature extraction system 116 can rely on a group of workers who are known to have satisfactory reputation scores to establish the consensus. Further, in some implementations, the feature extraction system 116 can form a weighted average of answers given by the workers in computing the consensus, where the weights are based on the reputation scores associated with the respective workers.

Next consider the collection of task-focused features. A task-focused feature may pertain to any task-related scope, e.g., by describing a characteristic of a single task, a characteristic of a task type, or a characteristic of all tasks. Alternatively, or in addition, a task-focused feature may describe any property of one or more tasks, such as a structural property of the task(s), or a response profile of the task(s). The structure of a task describes the user interface characteristics of the task, e.g., as defined by the manner in which the question is phrased and/or the range of options associated with its answer set, and so on. The response profile of a task describes the responses that one or more workers have provided for the task. The response profile, in turn, can be expressed with respect to any temporal scope, worker-related scope, and/or task-related scope. Finally, a task-focused feature may use any metric(s) to describe its characteristic, as set above.

Last consider the collection of system-focused features. In the realm of actual-aspect features, one or more system-focused features can characterize the market to which the crowdsourcing environment 102 is directed. The market may pertain to the subject matter of the tasks, the target audience of the tasks, etc. One or more other system-focused features may identify whether the crowdsourcing environment 102 employs any supplemental functionality to reduce the presence of spam agents and low-quality work, such as firewalls, spam detection engines, etc. One or more other system-focused features may describe the incentive structure of the crowdsourcing environment 102. One other more other system-focused features may identify some high-level aspects of the worker population that participates in the crowdsourcing environment 102, such as by describing the average number of workers on a daily basis, the current number of workers, etc. One or more other system-focused features may describe some high-level aspects of the tasks that are hosted by the crowdsourcing environment 102, such as the number of tasks that are currently being hosted, the origins of those tasks, etc. One or more other system-focused features may describe the some aspect of the traffic characteristics of the crowdsourcing environment 102, such as its throughput, peak load, etc. Further, to repeat, any of the features described above may have a subjective counterpart, corresponding to a worker's knowledge of and/or subjective reaction to a particular actual aspect of the crowdsourcing environment 102.

Section C (below) provides a representative sampling of some features that may be used in one non-limiting crowdsourcing environment. However, the features described in that section, as well as the dimensions set forth above, are set forth by way of example, not limitation. Other crowdsourcing environments can adopt feature sets that differ in any respect compared to the features described herein.

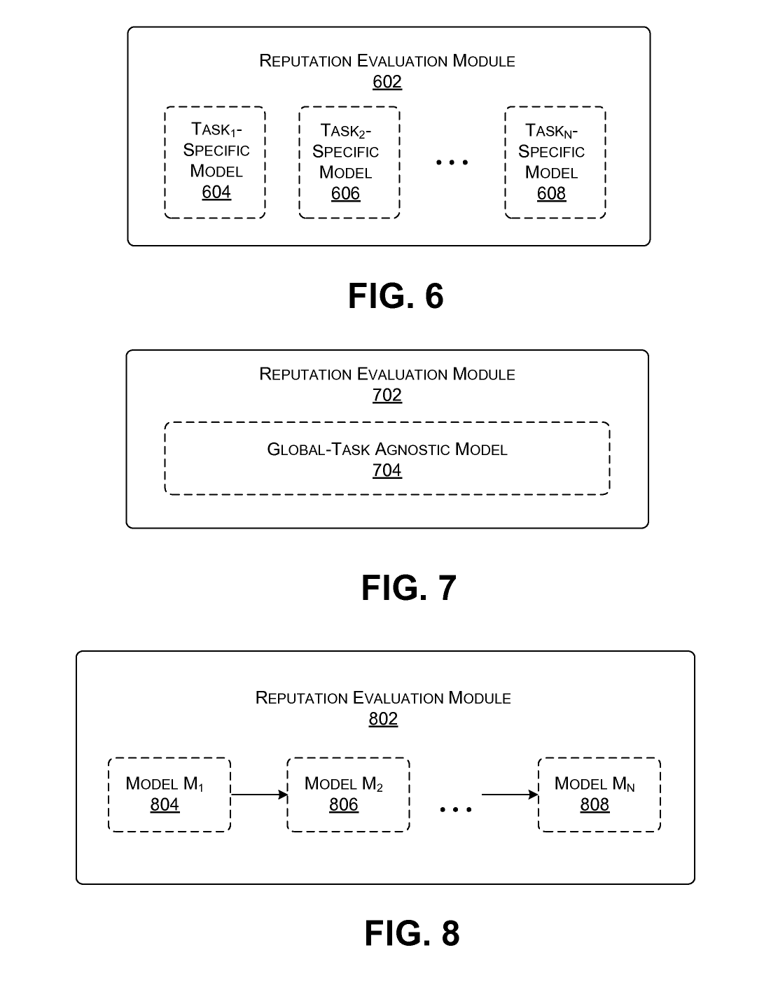

Advancing now to FIGS. 6-8, these figures show three respective instantiations (602, 702, 802) of the reputation evaluation module 304 of FIG. 3, which may correspond to a standalone module, or a module that is integrated with the spam evaluation module 302. In the case of FIG. 6, a reputation evaluation module 602 includes plural task-specific models (e.g., models 604, 606, . . . 608). Each task-specific model is configured to perform analysis for a particular task or task type. The reputation evaluation module 602 may select a particular task-specific model to apply to suit the task that is currently under consideration.

In the case of FIG. 7, a reputation evaluation module 702 provides a single global task-agnostic model 704. The global task-agnostic model 704 is configured to perform analysis for plural tasks, e.g., by leveraging the use of meta-level features in the manner described above. In another implementation (not shown), plural task-agnostic models can be perform analysis for different families of tasks. Each family refers to class of tasks having one or more common characteristics. In that embodiment, the reputation evaluation module 702 may select a particular task-agnostic model to suit the kind of task under consideration.

In the case of FIG. 8, a reputation evaluation module 802 provides two or more models (804, 806, . . . 808) which perform their analyses in respective stages. That is, the output of the first model 804 provides an input to the second model 806, the output of the second model 806 provides an input to a third model (not shown), and so on. To cite one application of the configuration shown in FIG. 8, the first model 804 can determine the type of task that is under consideration. The first model 804 may then invoke a particular secondary model that is best suited to handle the task. Or different stages of analysis can be used to determine different aspects of a worker's reputation, such as an accuracy-based component, a timeliness-based component, a volume-based component, etc.

Still other ways of implementing the reputation evaluation module 304 (of FIG. 3) are possible. Further, the above description was predicated on the assumption that the evaluation system 118 performs separate analysis for each worker and for each task. But the training system 126 can alternatively, or in addition, generate one or more models that are designed to generate a single reputation score for a user with respect to all tasks that the worker has performed or may perform.

B. Illustrative Processes

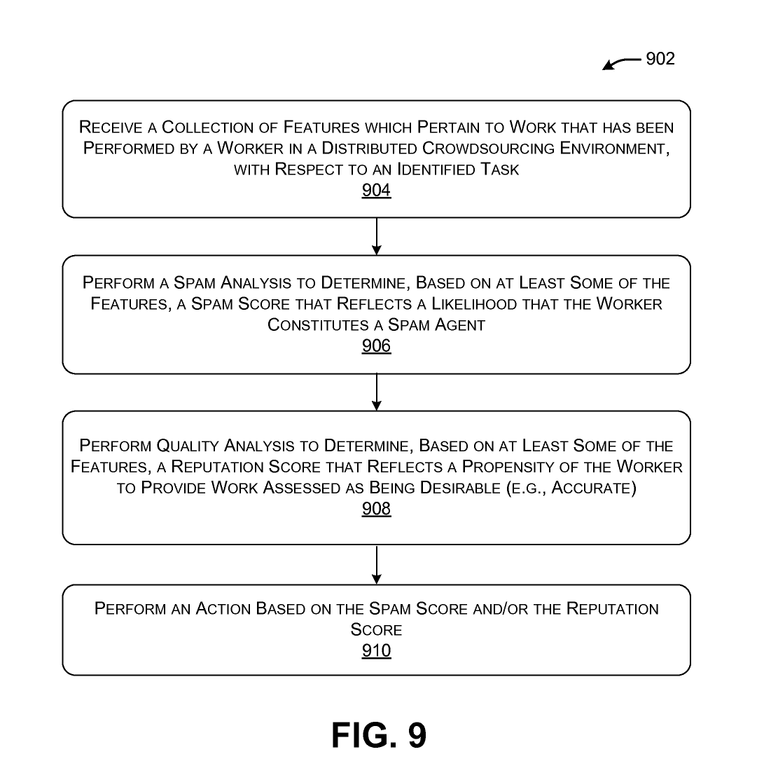

FIGS. 9-11 explain the operation of different parts of the crowdsourcing environment 102 of FIG. 1 in flowchart form. Since the principles underlying the operation of the environment 102 have already been described in Section A, certain operations will be addressed in summary fashion in this section.

Starting with FIG. 9, this figure shows a process 902 that summarizes one illustrative manner of operation of the worker evaluation system 118 of FIG. 3. In block 904, the evaluation system 118 receives a collection of features that pertain to work that has been performed by a worker with respect to an identified task. The feature extraction system 116 computes those features based on the raw data provided by the data collection system 104. In block 906, the evaluation system 118 performs spam analysis to determine a spam score that reflects the likelihood that the worker constitutes a spam agent, based on at least some of the features. In block 908, the evaluation system 118 performs quality analysis to determine a reputation score which reflects a propensity of the worker to provide work assessed as being desirable (e.g., accurate), with respect to the identified task, based on at least some of the features. In one case, the evaluation system 118 performs the spam analysis and the quality analysis as part of a single integrated operation. In another case, the evaluation system 118 performs the spam analysis prior to the quality analysis, where the quality analysis is performed contingent on the outcome of the spam analysis. That is, in that case, the evaluation system 118 performs the spam analysis upon determining that the worker is an honest entity, i.e., not a spam agent. In block 910, the evaluation system 118 performs any action based on the spam score and/or the reputation score.

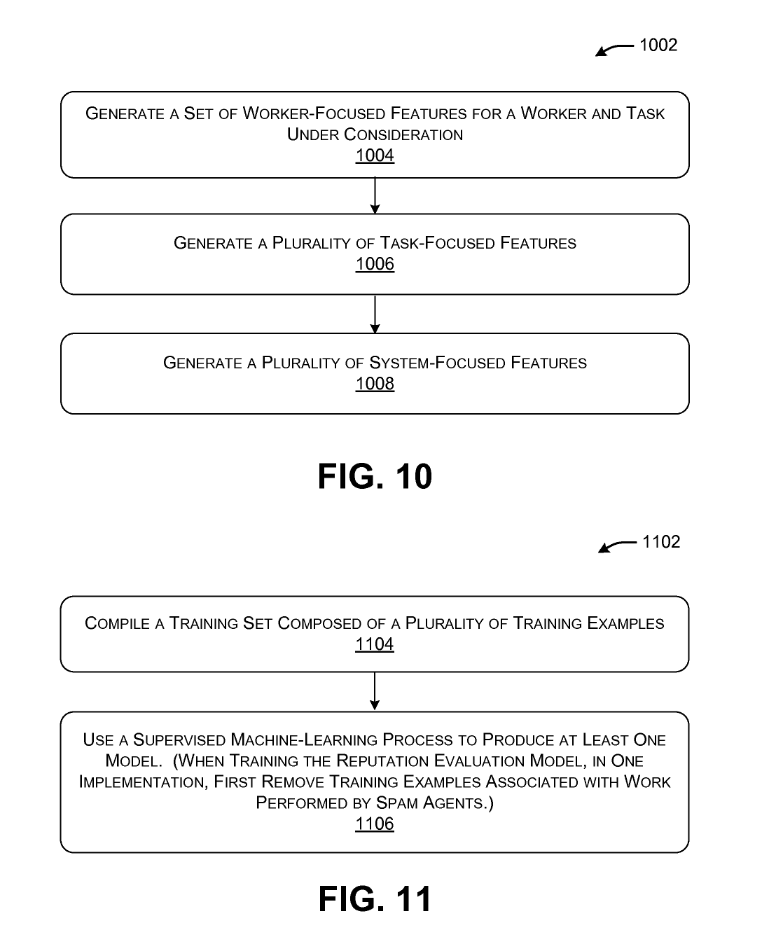

FIG. 10 shows a process 1002 that describes one manner of operation of the feature extraction system 116. In block 1004, the feature extraction system 116 generates a subset of worker-focused features, each of which characterizes work performed by at least one worker in the crowdsourcing environment 102. In block 1006, the feature extraction system 116 generates a subset of task-focused features, each of which characterizes at least one task performed in the crowdsourcing environment 102. In block 1008, the feature extraction system 116 generates a subset of system-focused features, each of which characterizes an aspect of the configuration of the crowdsourcing environment 102. These blocks (1004, 1006, 1008) can be performed in any order. Each category of the features described above may further be partitioned into actual-aspect features (which describe actual components, events, conditions, etc. in the crowdsourcing environment 102) and belief-focused features (which describe a worker's perception of the actual aspects). Further, some of the features collected in the process 1002 may correspond to meta-level features, insofar as they characterize a context in which work is performed by a worker, but without explicit reference to the work performed by a particular worker. One class of meta-level features characterizes a task under consideration, e.g., by describing the structure of the task under consideration, the distribution of responses associated with the task, and so on.

FIG. 11 shows a process 1102 that describes one manner of operation of the training system 126. In block 1102, the training system 126 compiles a training set composed of a plurality of training examples. In block 1104, the training system 126 uses a supervised machine-learning process to produce at least one model, based on the training set.

More specifically, each training example may include a collection of features that describe at least one prior occasion in which a particular prior worker has performed prior work on a particular task, and a context in which the prior work was performed, together with a label. The training system 126 can rely on the feature extraction system 116 to generate these features. For instance, the features may include any of the above-described worker-focused features, task-focused features, and system-focused features, some of which may pertain to actual aspects of the crowdsourcing environment 102, and others of which may pertain to the perceptions of a worker under consideration. Some features can also optionally describe the relationships among other features.

The label associated with the training example corresponds to an evaluation of the prior worker's activity. For example, consider the case in which the model under development corresponds to the spam evaluation model 306 of FIG. 3; here, the outcome indicates whether or not the worker corresponds to a spam agent. Consider next the case in which the model under development corresponds to the reputation evaluation model 308 of FIG. 3; here, in one case, the outcome represents the accuracy of the worker's answer. The accuracy of the worker's answer can be assessed in any of the ways described above, such as by making reference to a pre-defined correct answer (for a gold set task), a consensus-based correct answer, etc.

In one case, the training system 126 can also associate a weight with each training example that reflects the origin of the label. For example, the training system 126 can assign the most favorable weight to training examples having labels that derive from pre-established correct (or otherwise desirable) responses. The training system 126 can assign a less favorable weight to training examples having labels derived from consensus-based correct (or otherwise desirable) responses, and so on.

In one implementation, the training system 126 can generate the reputation evaluation model 308 (of FIG. 3) in a manner which parallels the two-stage processing described above. More particularly, the training system 126 can first remove training examples from the training set which correspond to the work perform by spam agents, to produce a spam-removed training set. The training system 126 can then train the reputation evaluation model 308 based on the spam-removed training set. For a single-stage model, the training system 126 can dispense with the preliminary step of removing examples associated with spam agents.

In the context of FIG. 6, the training system 126 may produce plural task-specific models (604, 606, . . . 608) for respective tasks or task types. In the context of FIG. 7, the training system 126 produces at least one task-agnostic model 704, which applies to plural tasks and task types. In the context of FIG. 8, the training system 126 produces plural models (804, 806, . . . 808) associated with plural stages of analysis. Further, the training system 126 can also separately produce the spam evaluation model 306 for use by the spam evaluation module 302, that is, in those implementations that rely on a two-stage analysis technique.

The training system 126 can use the same machine-learning technique to train each model, or different respective techniques to train different respective models. In addition, or alternatively, the evaluation system 118 can construct one or more models through some technique other than a machine-learning technique. For example, in a two-stage analysis technique, the evaluation system 118 can use an algorithmic technique to implement the spam evaluation model 306, and a machine-learning technique to build the reputation evaluation model 308.

In one non-limiting implementation, the training system 126 uses a boosted decision tree approach to produce at least one model. In that case, the model defines a space having different domains of analysis, associated with different parts of the decision tree. The model can use the meta-level features to identify a particular domain of analysis to be explored, for a particular task or context under consideration. Stated in another way, a model produced in the above manner can be conceptualized as an agglomeration of different models that are appropriate for different respective tasks or contexts; the meta-level features serve as the signals which activate a particular sub-model within the overall model, based on the task or context under consideration. The training process automatically determines the structure of the decision tree model.

More generally, the training process has the effect of automatically identifying an importance level associated with different features, e.g., based on the weight assigned to a particular feature. Optionally, a developer may wish to exclude a subset of under-performing features from the model(s) which it deploys to the evaluation system 118. This provision will reduce the complexity of the model(s), and correspondingly reduce the consumption of system resources that are necessary to run the model(s).

In another implementation, the training system 126 can use any technique to generate values for the parameters associated with a probabilistic graphical model, such as the graphical model 402 shown in FIG. 4. For example, the training system 126 can generate the values using any Markov chain Monte Carlo technique (such as Gibbs sampling), any variational method, any loopy belief propagation method, and so on.

Although not represented in FIG. 11, the training system 126 can use test sets and validation sets in a known manner to evaluate and finalize the model(s) which it generates. For example, the training system 126 can use these sets to generate parameter values associated with the model(s).

Further note that the training system 126 can dynamically update the training examples in the data store 128 based on the scores assigned by the evaluation system 118, in the course of its real-time operation. The training system 126 can update its model(s), based on the updated training data, on any basis. For example, the training system 126 can update its model(s) on a periodic basis (e.g., every week, month, etc.) and/or on an event driven basis.

C. Representative Features

This section describes a sampling of some features that the feature extraction system 116 may produce, in one non-limiting implementation of the crowdsourcing environment 102. The first batch of features (below) refers to worker-related behavior performed by one or more workers, with respect to one or more identified tasks.

CurrentDwellTime.

This feature describes an amount of time that a worker spends on a most recent task.

NumberOfTasksCompleted.

This feature describes a number of tasks completed by the worker.

NumberOfCorrectSystemConsensusTasks.

This task describes a number of tasks completed by the worker that are correct (based a consensus standard of correctness), for tasks that have reached consensus.

RatioOfCorrectSystemConsensusTasks.

This feature describes a number of correct responses to tasks by the worker, divided by a number of tasks completed by the worker that have also reached consensus.

NumberOfTasksOfThisTypeByWorker.

This feature describes a number of tasks of a specified type that have been completed by the worker.

NumberOfTasksOfThisTypeByOthers.

This feature describes a total number of tasks of a specified type that have been completed by all other workers.

DiffNumberOfTasksOfThisTypeTotalNumberOfTasksByOthers.

This feature describes the difference between the two features referred to immediately above.

NumberOfUniqueWorkersForTasksOfThisType.

This feature describes a number of workers who have worked on a task of a specified type.

PercentageDoneByWorker.

This feature describes a percentage of completed tasks in the crowdsourcing environment 102 which have been performed by the worker.

MeanDwellTimeWorker.

This feature describes the mean dwell time of the current worker with respect to one or more tasks.

MeanDwellTimeOthers.

This feature describes the mean dwell time of all other workers with respect to one or more tasks.

MeanDwellTimeDifference.

This feature describes the difference between the two features described immediately above.

IsCurrentDwellLongerThanWorkerAverage.

This feature, if true, indicates that the current dwell time for the worker is longer than the worker's average dwell time.

CurrentDwellDiffWithWorkerAverage.

This feature describes a difference between the current dwell time for the worker and the worker's average dwell time.

CurrentDwellDiffWithOthersAverage.

This feature describes a difference between the current dwell time of the worker and the average dwell time of others workers.

MinDwellTime.

This feature describes the minimum dwell time of the worker with respect to some time span and/or task selection.

MaxDwellTime.

This feature describes the maximum dwell time of the worker with respect to some time span and/or task selection.

DiffDwellMinMean.

This feature describes the difference between the minimum dwell time and mean dwell time of the worker.

DiffDwellMaxMean.

This feature describes the difference between the maximum dwell time and the mean dwell time of the worker.

DifferenceShannonBetweenWorkerOnTask.

This feature describes the difference between the vote entropy of the worker and the vote entropy of other workers.

NumDataPoints.

This feature describes a number of data points that the crowdsourcing environment 102 has collected which pertain to the worker.

SpamScore.

This feature describes the spam score as computed by the spam evaluation module 302 of FIG. 3.

GoldHitSetAgreement.

This feature describes a ratio of gold standard tasks in which the worker agrees with the correct answer. Recall that a gold standard task is a task that with a known correct answer, established by definition.

NumDaysActiveForThisWorker.

This feature describes a number of days that the worker has been active in the crowdsourcing environment.

AverageJudgementsDoneForThisWorkerPerActiveDay.

This feature describes, per active day, the average number of tasks completed by the worker.

AverageJudgementsPerHourForThisWorker.

This feature describes an average number of judgments completed by the worker per hour.

MaxVoteProb.

This feature describes, among a set of possible answers to a task, the ratio of the most common answer for the worker.

MinVoteProb.

This feature describes, among the possible answers to a task, the ratio of the least common answer for the worker.

Variance.

This feature describes the variance of the vote distribution of the worker.

The following list provides a sampling of task-focused features.

TaskConsensusRatio.

This feature describes a number of tasks of this type that have reached consensus, with respect to a total number of tasks of this type.

TaskCorrectConsensus.

This feature describes, among the tasks of this type that have reached consensus, the ratio of responses that agree with the consensus.

TaskMaxVote.

This feature describes the likelihood of the most popular answer for the tasks of the current type.

TaskMinVote.

This feature describes the likelihood of the least popular answer for the tasks of the current type.

TaskVoteVariance.

This feature describes the variance of the vote distribution for the tasks of the current type.

TaskMaxCons.

This feature describes the likelihood of the most popular consensus among the tasks of the current type.

TaskMinCons.

This feature describes the likelihood of the least popular consensus among tasks of the current type.

TaskConsVariance.

This feature describes the variance of the consensus distribution among the tasks of the current type.

NumberOfAnswers.

This feature describes a number of answers for a specified task.

D. Representative Computing Functionality

FIG. 12 shows computing functionality 1202 that can be used to implement any aspect of the environment 102 of FIG. 1, e.g., as implemented by the computing equipment of FIG. 2. For instance, the type of computing functionality 1202 shown in FIG. 12 can be used to implement any component(s) of the work processing framework 202 of FIG. 2, and/or any aspect of the user computing devices (204, 206, . . . ) which workers use to interact with the work processing framework 202. In all cases, the computing functionality 1202 represents one or more physical and tangible processing mechanisms.

The computing functionality 1202 can include one or more processing devices 1204, such as one or more central processing units (CPUs), and/or one or more graphical processing units (GPUs), and so on.

The computing functionality 1202 can also include any storage resources 1206 for storing any kind of information, such as code, settings, data, etc. Without limitation, for instance, the storage resources 1206 may include any of RAM of any type(s), ROM of any type(s), flash devices, hard disks, optical disks, and so on. More generally, any storage resource can use any technology for storing information. Further, any storage resource may provide volatile or non-volatile retention of information. Further, any storage resource may represent a fixed or removable component of the computing functionality 1202. The computing functionality 1202 may perform any of the functions described above when the processing devices 1204 carry out instructions stored in any storage resource or combination of storage resources.

As to terminology, any of the storage resources 1206, or any combination of the storage resources 1206, may be regarded as a computer readable medium. In many cases, a computer readable medium represents some form of physical and tangible entity. The term computer readable medium also encompasses propagated signals, e.g., transmitted or received via physical conduit and/or air or other wireless medium, etc. However, the specific terms “computer readable storage medium” and “computer readable medium device” expressly exclude propagated signals per se, while including all other forms of computer readable media.

The computing functionality 1202 also includes one or more drive mechanisms 1208 for interacting with any storage resource, such as a hard disk drive mechanism, an optical disk drive mechanism, and so on.

The computing functionality 1202 also includes an input/output module 1210 for receiving various inputs (via input devices 1212), and for providing various outputs (via output devices 1214). Illustrative input devices include a keyboard device, a mouse input device, a touchscreen input device, a digitizing pad, one or more video cameras, one or more depth cameras, a free space gesture recognition mechanism, one or more microphones, a voice recognition mechanism, any movement detection mechanisms (e.g., accelerometers, gyroscopes, etc.), and so on. One particular output mechanism may include a presentation device 1216 and an associated graphical user interface (GUI) 1218. Other output devices include a printer, a model-generating mechanism, a tactile output mechanism, an archival mechanism (for storing output information), and so on. The computing functionality 1202 can also include one or more network interfaces 1220 for exchanging data with other devices via one or more communication conduits 1222. One or more communication buses 1224 communicatively couple the above-described components together.

The communication conduit(s) 1222 can be implemented in any manner, e.g., by a local area network, a wide area network (e.g., the Internet), point-to-point connections, etc., or any combination thereof. The communication conduit(s) 1222 can include any combination of hardwired links, wireless links, routers, gateway functionality, name servers, etc., governed by any protocol or combination of protocols.

Alternatively, or in addition, any of the functions described in the preceding sections can be performed, at least in part, by one or more hardware logic components. For example, without limitation, the computing functionality 1202 can be implemented using one or more of: Field-programmable Gate Arrays (FPGAs); Application-specific Integrated Circuits (ASICs); Application-specific Standard Products (ASSPs); System-on-a-chip systems (SOCs); Complex Programmable Logic Devices (CPLDs), etc.

In closing, the functionality described herein can employ various mechanisms to ensure that any user data is handled in a manner that conforms to applicable laws, social norms, and the expectations and preferences of individual users. For example, the functionality can allow a user to expressly opt in to (and then expressly opt out of) the provisions of the functionality. The functionality can also provide suitable security mechanisms to ensure the privacy of the user data (such as data-sanitizing mechanisms, encryption mechanisms, password-protection mechanisms, etc.).

Further, the description may have described various concepts in the context of illustrative challenges or problems. This manner of explanation does not constitute a representation that others have appreciated and/or articulated the challenges or problems in the manner specified herein. Further, the claimed subject matter is not limited to implementations that solve any or all of the noted challenges/problems.

More generally, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, implemented by one or more computing devices, for evaluating work in a crowdsourcing environment, comprising:
receiving a collection of features associated with work that has been performed by a worker, in the crowdsourcing environment, with respect to an identified task;
performing spam analysis to determine, based on at least some of the features, a spam score that reflects a likelihood that the worker constitutes a spam agent;
performing quality analysis to determine, based on at least some of the features, a reputation score which reflects a propensity of the worker to provide work assessed as being desirable, with respect to the identified task; and
performing an action based on the spam score and/or the reputation score,
the quality analysis being based on an application of at least one reputation evaluation model produced by a supervised machine learning process.

2. The method of claim 1,
wherein the spam analysis is performed in a first stage, and the quality analysis is performed in a second stage,
and wherein the quality analysis is performed upon a determination that the worker is not a spam agent

3. The method of claim 1, wherein at least a subset of the features correspond to worker-focused features, each of which characterizes work performed by at least one worker in the crowdsourcing environment.

4. The method of claim 3, wherein at least one worker-focused feature characterizes an amount of work performed by the worker.

5. The method of claim 3, wherein at least one worker-focused feature characterizes an accuracy of work performed by the worker.

6. The method of claim 1, wherein at least a subset of the features correspond to task-focused features, each of which characterizes at least one task performed in the crowdsourcing environment.

7. The method of claim 6, wherein at least one task-focused feature characterizes a susceptibility of the identified task to spam-related activity.

8. The method of claim 6, wherein at least one task-focused feature characterizes an assessed difficulty level of the identified task.

9. The method of claim 1, wherein at least a subset of features correspond to system-focused features, each of which characterizes an aspect of a configuration of the crowdsourcing environment.

10. The method of claim 9, wherein at least one system-focused feature describes an incentive structure of the crowdsourcing environment.

11. The method of claim 9, wherein at least one system-focused feature describes any functionality employed by the crowdsourcing environment to reduce occurrence of spam-related activity and low quality work.

12. The method of claim 1, wherein at least a subset of features correspond to belief-focused focused features, each of which pertains to a perception, by the worker, of an actual aspect of the crowdsourcing environment.

13. The method of claim 12, wherein at least one belief-focused feature describes a perception, by the worker, of a susceptibility of the identified task to spam-related activity, and/or an ability of the crowdsourcing environment to detect the spam-related activity.

14. The method of claim 1, wherein said at least one reputation evaluation model that is used in the quality analysis corresponds to a task-specific model that applies to the identified task, and is selected from among a set of task-specific models.

15. The method of claim 1, wherein said at least one reputation evaluation model that is used in the quality analysis corresponds to a task-agnostic model that applies to a plurality of different tasks.

16. The method of claim 1, further comprising producing said at least one reputation evaluation model by:
compiling a training set composed of a plurality of training examples, each training example including:
a set of features which are associated with prior work performed by a prior worker with respect to a prior task, together with a context in which the prior work was performed; and
a label which describes an assessed outcome of the prior task;
removing any training examples associated with spam agents, to provide a spam-removed training set; and
using the supervised machine-learning process to produce said at least one reputation evaluation model based on the spam-removed training set.

17. The method of claim 1, wherein said at least one reputation evaluation model that is produced corresponds to at least one decision tree model.

18. A computer readable storage medium for storing computer readable instructions, the computer readable instructions providing a worker evaluation system when executed by one or more processing devices, the computer readable instructions comprising:
logic configured to receive a plurality of features which are associated with work that has been performed by a worker, in a crowdsourcing environment, with respect to an identified task; and
logic configured to determine, by applying at least one task-agnostic reputation evaluation model produced in a supervised machine-learning process, and based on at least some of the features, a reputation score which reflects a propensity of the worker to provide work assessed as being desirable, with respect to the identified task,
a subset of the features corresponding to worker-focused features, each of which characterizes work performed by at least one worker in the crowdsourcing environment,
another subset of the features corresponding to task-focused features, each of which characterizes at least one task performed in the crowdsourcing environment, and
another subset of the features corresponding to system-focused features, each of which characterizes an aspect of a configuration of the crowdsourcing environment.

19. The computer readable storage medium of claim 18, further comprising:
logic configured to determine, based on at least some of the features, a spam score that reflects a likelihood that the worker constitutes a spam agent,
wherein said logic configured to determine the reputation score is invoked only upon a determination that the worker is not a spam agent.

20. At least one computing device which implements at least part of a crowd sourcing environment, comprising:
a feature extraction system for generating a plurality of features which pertain to work that has been performed by a worker, in the crowdsourcing environment, with respect to an identified task,
a subset of the features corresponding to worker-specific features, each of which characterizes work performed by the worker in the crowdsourcing environment, and
another subset of the features corresponding to meta-level features, each of which characterizes a context in which work is performed by the worker, but without specific reference to the work performed by the worker;
a worker evaluation system comprising:
a spam evaluation module configured to determine, based on at least some of the plurality of features, a spam score that reflects a likelihood that the worker constitutes a spam agent; and
a reputation evaluation module configured to determine, based on at least some of the plurality of features, a reputation score which reflects a propensity of the worker to provide work assessed as being desirable, with respect to the identified task; and
an action system configured to perform an action based on the spam score and/or the reputation score,
the reputation evaluation module being configured to perform its analysis upon a determination that the worker is not a spam agent, and
the work evaluation module being configured to perform its analysis based on an application of at least one reputation evaluation model produced in a supervised machine learning process.
